(19) United States
(12) Patent Application Publication
(10) Pub. No.: US 2009/0219501 A1
(43) Pub. Date: Sep. 3, 2009

(54) OPTICAL UNIT USING OPTICAL ATTENUATOR AND PRINTING APPARATUS PROVIDED THEREWITH

(75) Inventors: Jie ZHANG, Medford, MA (US); Ming LI, Chelmsford, MA (US); Yosuke MIZUYAMA, Arlington, MA (US)

Correspondence Address: GREENBLUM & BERNSTEIN, P.L.C., 1950 ROLAND CLARKE PLACE, RESTON, VA, 20191, US

(73) Assignee: MATSUSHITA ELECTRIC INDUSTRIAL CO., LTD., Osaka (JP)

(21) Appl. No.: 12/039,885

(22) Filed: Feb. 29, 2008

(51) Int. Cl. G03B 27/54

(52) U.S. Cl. 355/70

(57) ABSTRACT

An optical unit for a printing apparatus, and a printing apparatus that uses the optical unit. The optical unit includes a plurality of light emitting elements, a lens that collects light from the plurality of light emitting elements, and a light filter that is positioned in light paths from the plurality of light emitting elements. The light filter compensates an intensity of the lights which pass through the lens.

### BACK GROUND OF THE INVENTION

1. Field of the Invention

The present invention relates to an electro photographic printing apparatus, and in particular, to an electro photographic printing apparatus that uses diffusive light sources.

2. Description of the Related Art

There are several types of electronic printing devices, such as, for example, wire dot printers, electro photographic printers, and inkjet printers. Currently, electro photography and inkjet are two leading electronic printing systems for use in office, home, small office-home office (SOHO) or industrial environments. Electro photographic printing devices are of the relatively faster printing speed type and are capable of massive print jobs, while inkjet printers are generally used for relatively slower and smaller print jobs while providing a high print quality.

Electro photography is a method of printing electronic information using a series of basic steps: exposure, development, and image transfer, just like photography. A laser printer is a typical commercial machine making use of electro photography.

Recently, Organic Light Emitting Diode (OLED) light sources have been employed for applications in next generation printing systems, because they have a small footprint and the cost of fabricating them is low. Therefore, by using OLED light sources, it is possible to manufacture compact electro photographic printers at low cost.

However, there are some key requirements for using OLED light sources. OLED light sources require a high optical coupling efficiency so that an OLED element can operate at a low current, which extends the life of the OLED element. Second, a high modulation is necessary (e.g., Modulation Transfer Function (MTF) should be close to 100%) because modulation determines the resolution of the printed image. Modulation can be assessed by MTF, which is defined as a measure of how images on an OPC (Organic Photo Conductive) drum from two light sources set apart at a certain distance on a light source array are distinguishable (see FIG. 13) and is expressed in a formula as:

MTF=(Imax−Imin)/(Imax+Imin)

where Imax and Imin are a maximum intensity and a minimum intensity, respectively, and P1 and P2 are positions of two separate light sources with a separation |P2-P1|.

OLED light sources have a very large divergence angle (i.e., it can be described as a Lambertian light source), making it difficult to achieve a high coupling efficiency and good modulation.

It has been attempted to address this issue in prior devices by improving the extraction efficiency of light power from EL sources, where individual micro ball lenses are placed mostly contacting with each of the EL sources to extract as much light as possible and refract it towards an image plane (i.e., an OPC drum surface in the case of electro photography). FIG. 14 depicts an arrangement employing micro ball lenses. In this arrangement, the ball lens captures more light from EL light sources, but it is difficult to get a good image of ELs on a target (OPC drum). This leads to a problem of modulation. In addition, another problem is that the short focus is not able to keep the required working distance between the lens and OPC drum.

FIGS. 15A and 15B illustrate an alternative approach utilizing a GRIN lens used for the coupling device for a good image, good modulation and enough working distance between the lens and the OPC drum. A GRIN (Gradient Index) lens focuses light through a precisely controlled radial variation of the lens material's index of refraction from the optional axis to the edge of the lens. However, one critical issue of using a GRIN lens is that its coupling efficiency is less than 7%, since it is very difficult to make SELFOCUS lenses with a high Numerical Aperture (NA; small cone angle). For a low efficiency lens system, the OLED light sources have to be operated at a high current to get enough emitted energy (intensity). This reduces the lifetime of the OLED light sources. Therefore, people are looking for an alternative optical device for use in an electro photographic printing apparatus that employs an OLED light source.

FIG. 16 illustrates an array of diffusive light sources, a first lens disposed to receive light emitted from two or more light sources of the array, an aperture plate disposed to receive light from the first lens, and a second lens disposed to receive the light after passing through the plurality of apertures and to focus the light onto an image plane, such as a surface of an OPC drum. This construction provides a high coupling efficiency, by using a high NA lens, and a high MTF that is achieved by employing a pin-hole-array aperture in the aperture plate. However, this construction still exhibits limitations, in particular with regards to uniformity, as follows:
1. At the target plane, such as a surface of the OPC drum, the intensity of light from the OLED light sources is not uniform, depending on each pixel of the image, because the first lens collects more light emitted from the OLEDs located close to the center of the lens;
2. Although adjusting individual circular aperture sizes may compensate the intensity variation, varying circular aperture size results in a change of image size on a target, which is not desired;
3. There is very little tolerance in aperture alignment error, so alignment becomes a big challenge; and
4. The plurality of apertures constrain the beam in both the horizontal and vertical directions, which results in an unnecessary energy loss, considering the fact that the MFT is only a concern in the horizontal direction.

Thus, further improvement of the optical device for a printing apparatus using an OLED light source is required.

### SUMMARY OF THE INVENTION

It is thus an object of this invention to overcome the above-mentioned problems of a conventional printing apparatus that uses diffusive light sources and, more particularly, to provide a printing apparatus that makes efficient use of diffusive light sources while maintaining a uniform light intensity and energy distribution and maintaining a high MTF.

According to an aspect of the present invention, an optical unit for a printing apparatus includes a plurality of light emitting elements, a lens that collects light from the plurality of light emitting elements, and a light filter provided in a light path of the light from the plurality of light emitting elements to compensate for an intensity of the light passed through the lens.

According to another object of the present invention, an optical unit for a printing apparatus comprises a first light emitting element that emits a first light, a second light emitting element that emits a second light, a lens provided in light paths of the first light and the second light, the first light and the second light passing through the lens, and a light filter that compensates an intensity of the first and second light which passes through the lens.

According to a feature of the invention, the light filter has a first portion to transmit the first light from the lens and a second portion to transmit the second light from the lens. A light transparency of the first portion is different from a light transparency of the second portion.

Further, the light filter comprises a transparent substrate and a light absorbing layer provided on the transparent substrate, while a second lens transmits the first and second light transmitted from the light filter. The first and second light emitting elements may comprise an organic light emitting diode.

Accordingly to another object of the invention, a printing apparatus comprises a photosensitive member, a charger that charges the photosensitive member, an optical unit that irradiates the photosensitive member with light to form an electrostatic latent image, a developer that adheres toner to the photosensitive member to form a toner image of the electrostatic latent image, and a transferor that transfers the toner image onto a recording medium. The optical unit of the printing apparatus comprises a plurality of light emitting elements, a first lens that collects light from the plurality of light emitting elements, a second lens that transmits the light from the first lens to the photosensitive member, and a light filter provided between the first lens and the second. The light filter is positioned in light paths of the light from the plurality of light emitting elements and compensates an intensity of the light which passed through the lens.

### BRIEF DESCRIPTION OF THE DRAWINGS

The above and other objects, features and advantages of the present invention will be more clearly understood from the following detailed description taken in conjunction with the accompanying drawings, described in brief below.

FIG. 1 shows an exemplary configuration of a printer for a first embodiment of the present invention.

FIG. 2 illustrates an exemplary optical unit in the printer of FIG. 1.

FIG. 3 illustrates a subsystem of the optical unit in FIG. 2.

FIGS. 4A and 4B show functions of a light attenuator of a first embodiment.

FIGS. 5A, 5B and 6 illustrate a first example of the light attenuator of the first embodiment.

FIG. 7 illustrates a second example of the light attenuator of the first embodiment.

FIGS. 8A and 8B illustrate a third example of the light attenuator of the first embodiment.

FIGS. 9A, 9B and 10 illustrate a fourth example of the light attenuator of the first embodiment.

FIGS. 11A and 11B illustrate a fifth example of the light attenuator of the first embodiment.

FIGS. 12A, 12B and 12C show a non-sequential ray-tracing simulation result using a commercial optical design software called ZEMAX™.

FIG. 13 shows the intensity from two adjacent light sources.

FIGS. 14, 15A, 15B and 16 illustrate conventional optical units.

### DETAILED DESCRIPTION OF PREFERRED EMBODIMENTS

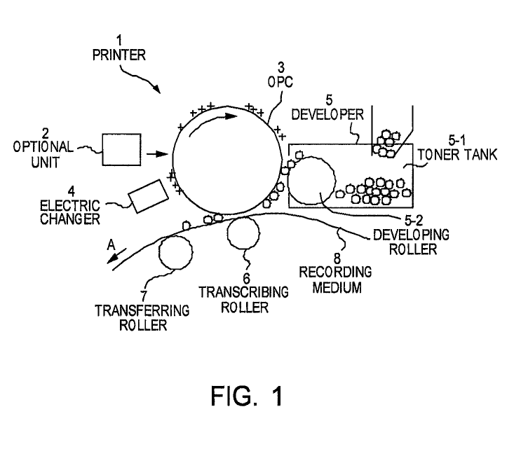

According to a first embodiment of the present invention, a printer 1 comprises an optical unit 2, an organic photo conductive drum (OPC drum) 3, an electric charger 4, a developer 5, a transcribing roller 6 and a transferring roller 7, as shown in FIG. 1.

Optical unit 2 comprises Organic Light Emitting Diode (OLED) light sources to illuminate light onto the OPC drum 3 in order to form an electrostatic latent image according to original image data to be printed on a recording medium 8. The OPC drum 3 is electrically charged by the electric charger 4 located at an up-rotation position before the light from the optical unit 2 is illuminated onto the surface of the OPC drum 3. Upon illumination of the light on the surface of the OPC drum 3, the illuminated portion changes to be neutralized due to a mechanism of organic photo conduction, wherein an electric current is created by a photo-conducting effect and an electrostatic latent image according to the original image is formed on the OPC drum 3. Developer 5 adheres toners in a toner tank 5-1 to the surface of the OPC drum 3 by developing roller 5-2. Then, a toner image is formed on the surface of the OPC drum 3 according to the original image data. The transcribing roller 6 nips a recording medium 8 with the OPC drum 3 and transcribes the toner image onto the recording medium 8. The transferring roller 7 transfers the recording medium 8, such as a paper, in a direction described by arrow A in FIG. 1.

In this first embodiment, printer 1 comprises a monochromatic printer having a single printing engine including optical unit 2, OPC drum 3, developer 5 and so on, but printer 1 can comprise a full color printer having several optical units for yellow, magenta, cyan and black. An example of a full color printer is disclosed in U.S. Pat. No. 7,116,345, which was assigned to Matsushita Electric Industrial CO., Ltd., and such U.S. Pat. No. 7,116,345 is hereby incorporated by reference in its entirety as though fully and completely set forth herein.

Further, while the present invention is described with reference to plural OLED light sources, it is understood that the invention is equally applicable to a single OLED light source.

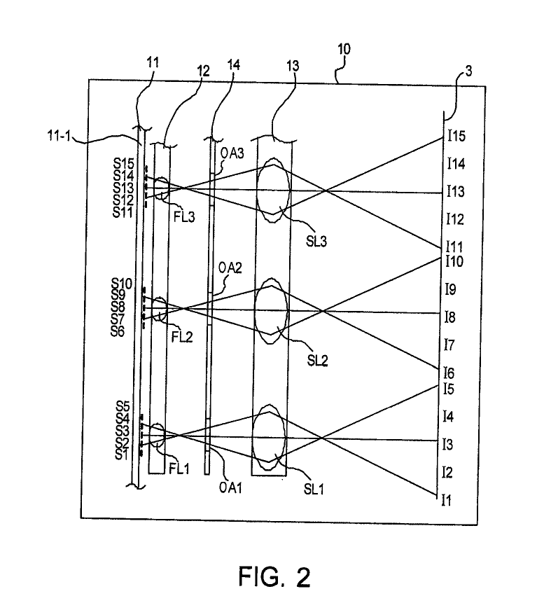

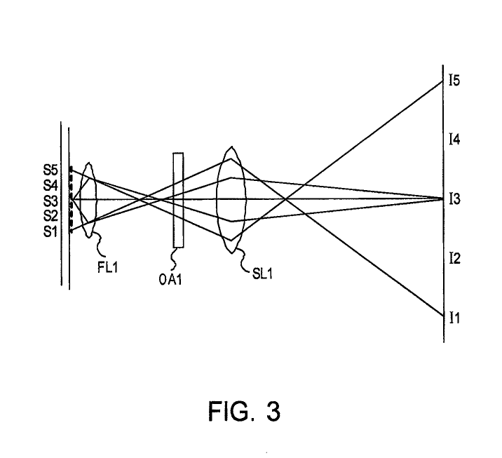

FIG. 2 illustrates an exemplary optical unit of the printer 1 of FIG. 1 and FIG. 3 illustrates a subsystem of the optical unit in FIG. 2.

Optical unit 2 includes OLED array 11 as the light source, first lens array 12, second lens array 13 and light attenuator unit 14. OLED array 11 comprises a plane substrate 11-1, on which, in the disclosed embodiment, about 10,000 pieces of organic electroluminescence (EL) elements (S1, S2, S3, S4, S5, . . . ) are aligned in one line, which is parallel with an axis of rotation of the OPC drum 3. However, it is understood that the actual number of EL elements is not critical to the present invention, and may be varied without departing from the spirit and/or scope of the invention. In this first embodiment, the EL elements are grouped by five adjacent elements, such as EL elements S1, S2, S3, S4 and S5 and each grouped elements are mounted on the plain substrate 11-1 having a predetermined distance, such as the distance between EL element S5 and S6. In the case that a resolution of the printer 1 is 600 dpi, a distance between adjacent EL elements, such as EL element S1 and S2, is preferably 42.3 μm, but it is not limited to this size. In this embodiment, EL elements are used for light sources, but a laser diode (LD) could be used without departing from the scope and/or spirit of the instant invention.

First lens array 12 comprises a plurality of first lens FL1, FL2, FL3, . . . , each of which covers each group of EL elements. For example, first lens FL1 covers the group of EL elements S1, S2, S3, S4 and S5. Second lens array 13 is located between the first lens array 12 and the OPC drum 3, in parallel with the first lens array 12, and comprises second lens SL1, SL2, SL3, . . . , each of which corresponds to the first lens FL1, FL2, FL3, . . . , respectively. One example of the first lens and second lens is an even-aspheric lens with a diameter of approximately 1˜2 mm, which is made of transparent glass or plastic at a visible wavelength. Light attenuator unit 14 is located between first lens array 12 and second lens array 13. Light attenuator unit 14 includes a plurality of light attenuators OA1, OA2, OA3 . . . , each of which corresponds to the first lens FL1, FL2, FL3, . . . , respectively. In this embodiment, each of the first lens array 12, the second lens array 14 and the light attenuator 13 is formed as a single unit, respectively, but each element (the first lens FL1, FL2, FL3, . . . , the second lens SL1, SL2, SL3, . . . , and attenuator LA1, LA2, LA3, . . . ) can be provided individually.

FIG. 3 shows the system magnification and optical configuration for a subsystem of the optical unit in FIG. 2. In FIG. 3, first lens FL1 collects light from EL elements S1, S2, S3, S4 and S5, and is preferably placed very close to EL elements S1, S2, S3, S4 and S5, for instance, with approximately 50 microns separation. In this way, the viewing angle from EL elements S1, S2, S3, S4 and S5 against the first lens FL1 increases so that the first lens FL1 collects more light. Second lens SL1 is placed after the first lens FL1 to deliver light to the OPC drum 3 that is positioned a certain distance away from the second lens SL1. Second lens SL1 delivers the light to the OPC drum 3 with a desired distance. It should be noted that the first lens FL1 could give an inverted image of the EL elements S1, S2, S3, S4 and S5 on light attenuator OA1 and the second lens SL1. Then, the second lens SL1 could invert the image from the light attenuator OA1. Accordingly, each pixel from the EL elements S1, S2, S3, S4 and S5 could be delivered onto image I1, I2, I3, I4 and I5 on the OPC drum 3, respectively.

As shown in FIG. 3, the image spacing on the OPC drum 3 can be different from that of the EL elements S1, S2, S3, S4 and S5. This follows from the result that the magnification of this lens system is not equal to one. In the case of an electro photographic printer, there is typically a need to deliver a lot of EL light and also a need to deliver the light far away. As pointed out above, these objectives tend to be at cross purposes to one another. To achieve these competing objectives, the first lens FL1 is positioned close to the EL elements S1, S2, S3, S4 and S5; in other words, the first lens FL1 is placed so that the viewing angle, more technically, numerical aperture (NA), becomes large. On the other hand, in order to deliver the light far away, the second lens SL1 is provided with a larger focal length, i.e., it has a small NA. The array of first lenses, second lenses and light attenuators may be a linear array or a multi-dimensional array.

Light attenuator OA1 is positioned between the first lens FL1 and the second lens SL1, preferably proximate a focal point of the light emitted from the first lens FL1. Attenuator OA1 functions as a ND (Neutral Density) filter to compensate for a variable intensity and energy distribution of the light emitted from the first lens FL1, to be described later.

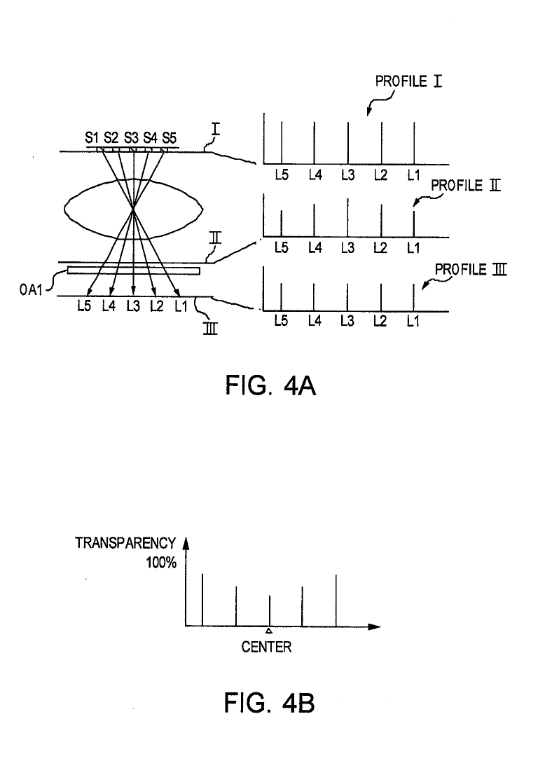

The function of the light attenuator OA1 is described with reference to FIG. 4A. Light attenuator OA1 has a light-absorbing portion, the light transparency of which changes according to a distance from the center of light attenuator OA1, as illustrated in FIG. 4B. For example, the light transparency at the center of light attenuator OA1 is lower than the light transparency at a peripheral portion thereof. Attenuation of light L3, which is emitted from EL element S3 and passed through the center part of the first lens FL1 and light attenuator OA1, is large compared to attenuation of light L1 which is emitted from EL element S1 and passed through the peripheral portion of the light attenuator OA1. In other words, light is emitted from EL elements S1, S2, S3, S4 and S5 almost uniformly (see Profile I in FIG. 4A), and its intensity and energy distribution becomes non-uniform (see Profile II in FIG. 4A), and then, it is compensated by the light attenuator OA1 to become uniform (see profile III in FIG. 4A). Therefore, the intensity and energy distribution is compensated by the light attenuator OA1, and the light, having a substantially uniform intensity and energy distribution, is delivered to the OPC drum 3.

It is well-known that light transmittance (1-absorbance (A)) through a material is determined by material absorption co-efficiency (α) and material thickness (L) according to Lamba-Beer law: A=exp(α·L).

Thus, for a design of this type of light attenuator, varying the absorption efficiency or varying the thickness changes the optical transmission. In principle, a change of absorption efficiency can be achieved by darkening materials (polymers, glasses, etc.) via dying, ion implantation, ion doping and light irradiation methods or bleaching materials via laser irradiation. A change of thickness can be achieved using convenient photo-lithography technology.

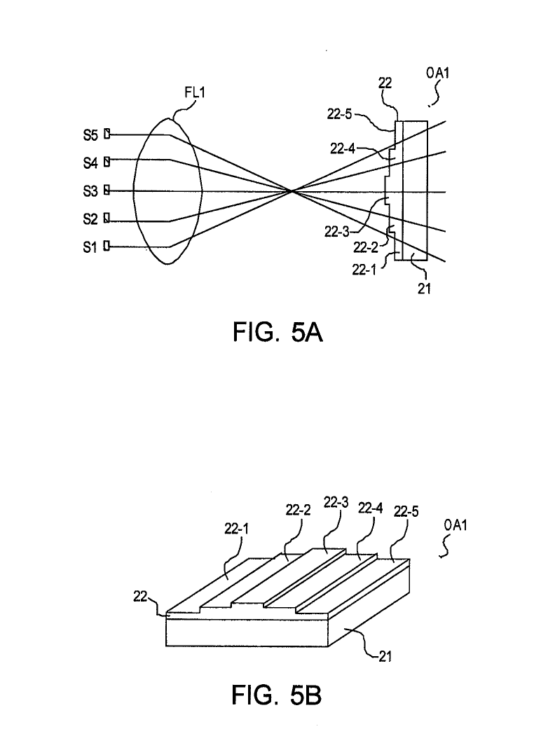

FIG. 5A is a cross-sectional view of a first example of the light attenuator OA1, based on changing a thickness of an absorbing layer, but maintaining a same absorption co-efficiency. FIG. 5B is a perspective view of the light alternator OA1 shown in FIG. 5A. In the disclosed embodiment, the light attenuator OA1 comprises a transparent glass substrate 21, which is preferably 0.7 mm in thickness, and a light absorbing layer 22, which is preferably 1-5 um in thickness, provided on the glass substrate 21. In this first embodiment, BK7, produced by Corning Co., which is based on SiO₂, is used for the glass substrate 21. The glass substrate 21 is stable and insensitive to heat. Instead of BK7, Acrylic Plastic can be used to replace the glass substrate 21, which reduces the cost of manufacture.

Light absorbing layer 22 comprises a light-absorbing material, such as, but not limited to, doped glasses, and polymers, and has areas 22-1, 22-2, 22-3, 22-4 and 22-5, each of which has a different thickness relative to each other. For example, area 22-3, located at a center portion of the light is thicker than areas 22-2 and 22-4 located adjacent to area 22-3, and areas 22-2 and 22-4 are thicker than areas 22-1 and 22-5 located at a peripheral portion of the light attenuator OA1. Therefore, each of areas 22-1, 22-2, 22-3, 22-4 and 22-5 exhibits a different light transparency. For example, the light transparency of areas 22-2 and 22-4 are larger than area 22-3, and is smaller than areas 22-1 and 22-5. In this example, the light transparency of areas 22-1, 22-2, 22-3, 22-4 and 22-5 is 100%, 90%, 80%, 90% and 100%, respectively, if the total non-uniformity of the beam after the first lens FL1 is approximately 20%.

As shown in FIG. 5A, light L1, L2, L3, L4 and L5, which are emitted by OLED elements S1, S2, S3, S4 and S5 and collected by the first lens FL1, pass through areas 22-5, 22-4, 22-3, 22-2 and 22-1, respectively. As explained above, the energy and intensity distribution of the light passed through the first lens FL1 is not uniform. In other words, lights L1 and L5 after the first lens FL1 have a small intensity and energy compared to light L3. However, by providing attenuator OA1 between the first lens FL1 and the second lens SL1, the lights L1, L2, L3, L4 and L5 delivered to the OPC drum 3 have an almost uniform intensity and energy so that a latent image developed on the OPC drum 3 is uniform.

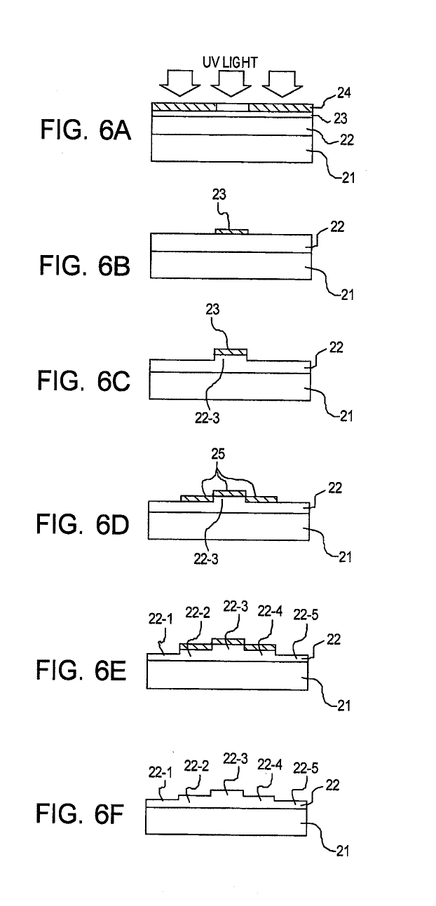

FIG. 6 illuminates a process for manufacturing the attenuator OA1.

In the first step, a photo resist 23, which is deposited on the light absorbing layer 22, is exposed with UV light so that a pattern of area 22-3 is transferred to the photo resist 23 (FIG. 6A). Parts of the photo resist 23 excluding area 22-3 is removed by a developer solution (FIG. 6B). Then, area 22-3 is formed at the center of the light absorbing layer using an ion etching process or equivalent process (FIG. 6C). After washing the remaining photo resist 23 away with a strong alkali solution, photo resist 25 for areas 22-2, 22-4 and 22-3 are formed on the light absorbing layer 22 in the same manner as the above (FIG. 6D). Then, areas 22-1, 22-2, 22-3, 22-4 and 22-5 are formed onto light absorbing layer 22 by an ion etching process (FIG. 6E) and the remaining photo resists 23-2 and 24-4 are washed away (FIG. 6F).

In this first embodiment, an ion etching process is used to form the light absorbing layer, but other processes, such as, but not limited to, for example, spattering and the like, can be used without departing from the scope and/or spirit of the invention.

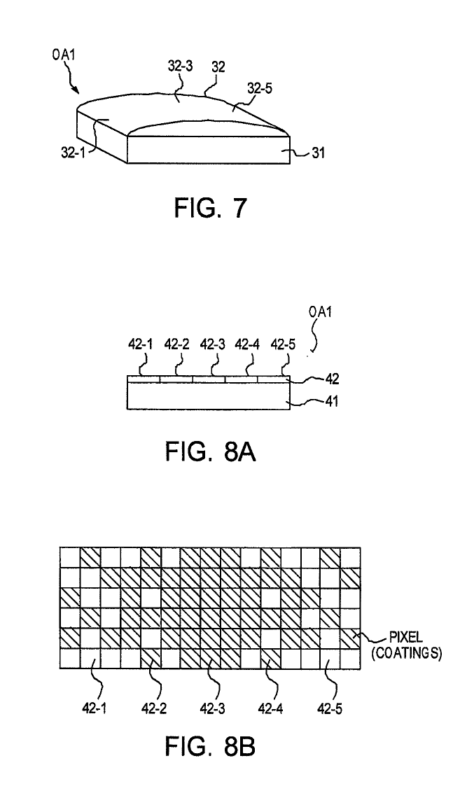

FIG. 7 is a perspective view of a second example of a light attenuator OA1, based on changing a thickness of the absorbing layer, but maintaining the same absorption co-efficiency.

In the second example, light attenuator OA1 comprises a SiO₂ based glass transparent substrate 31A hog-backed light absorbing layer 32 is deposited on the transparent substrate 31. In the disclosed embodiment, light absorbing layer 32 is made by polymers. However, other materials may be used without departing from the scope and/or spirit of the invention. As shown in FIG. 7, a thickness of the light absorbing layer 32 varies proportionally to a distance from its center portion, so that center portion 32-3 is thicker than peripheral portions 32-1 and 32-5. Therefore, light transparency at center portion 32-3 is low compared to peripheral portions 32-1 and 32-5. The fabrication of this kind of hog-backed profile can be done using the same method discussed with respect to FIG. 6. However, more processing steps are required.

FIG. 8A and FIG. 8B are a cross sectional view and a plain view, respectively, of a third example of a light attenuator OA1 of the present invention, based on a change of absorption co-efficiency of an absorbing layer, in which the thickness of the absorbing layer is maintained constant.

Light attenuator OA1 of the third example comprises a SiO₂ based glass transparent substrate 41 and dielectric coating layer 42 that is deposed on the transparent substrate 41, which is made by either metal-like films or dielectric films (such as, but not limited to SiO₂, AL₂O₃, TiO₂ and the like). Coating layer 42 has an almost uniform thickness over the transparent substrate 41, but comprises several areas 42-1, 42-2, 42-3, 42-4 and 42-5 having different light transparencies to each other. Different patterns (pixels) of dither matrix are formed on each surface of areas 42-1, 42-2, 42-3, 42-4 and 42-5 to cause different absorptions among areas 42-1, 42-2, 42-3, 42-4, 42-5, respectively. Because the density of the dither matrix formed on area 42-3 is high compared to areas 42-1, 42-2, 42-4, and the density of the dither matrix formed on areas 42-1 and 42-5 is low compared to areas 42-2 and 42-4, light transparency T1, T2, T3, T4 and T5 of areas 42-1, 42-2, 42-3, 42-4 and 42-5 of the dielectric coating layer 42 have a relationship as follows: T3<T2 (=T4)<T1 (=T5). Thus, non-uniformity of a light intensity and energy distribution after the first lens FL1 is compensated.

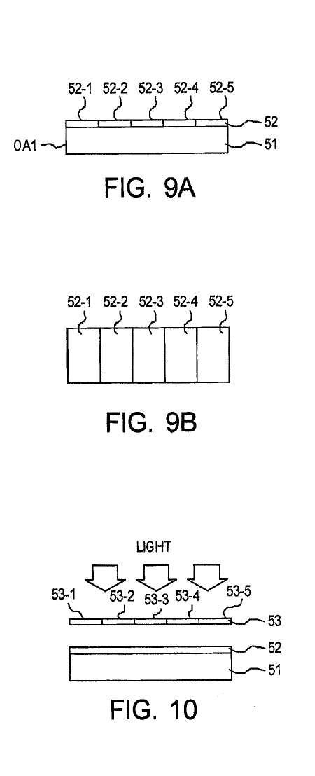

FIG. 9A and FIG. 9B are a cross sectional view and a plain view, respectively, of a fourth example of a light attenuator OA1, based on a change of absorption co-efficiency of an absorbing layer, while maintaining a uniform thickness of the absorbing layer.

Light attenuator OA1 of the fourth example comprises a transparent substrate 51 and photo-sensitive coating layer 52, which is deposited on transparent substrate 51, comparable to the substrate 41 of the third example. In the fourth example, however, photo-sensitive coating layer 52 has several areas 52-1, 52-2, 52-3, 52-4 and 52-5 that have different light transparencies to each other with a real gray scale (photo-sensitive polymers or dielectric materials have the properties of increasing light-induced absorption to adjust the transparency). Photosensitive coating layer 52 is formed on the transparent substrate 51 by, for example, a vacuum deposition or the like. The polymer films are formed on the substrate by, for example, a spin coating method. Dielectric films are formed by physical deposition methods. Lasers having a wavelength from near infrared (IR) to ultraviolet (UV) dielectric coating layer 52 via gray scale mask 53 change the transparency (see FIG. 10), and then, areas 51-1, 51-2, 51-3, 51-4 and 51-5 are formed on dielectric coating layer 52. However, it is understood that the present invention is not limited to a light attenuator as described in the fourth example, this being merely an exemplary example.

Gray scale mask 53 has several areas 53-1, 53-2, 53-3, 53-4 and 53-5 that correspond to areas 52-1, 52-2, 52-3, 52-4 and 52-5, respectively. The light transparency of areas 53-1, 53-2, 53-3, 53-4 and 53-5 is different relative to each other with a dither matrix as follows: (light transparency of area 53-3)>(light transparency of areas 53-2 and 53-4)>(light transparency of areas 53-1 and 53-5). In other words, area 52-3 of dielectric coating layer 52 is exposed to a more intense laser light than areas 52-1, 52-2, 52-4 and 52-5. Because photo-sensitive coating layer 52 comprises photo-sensitizers or color centers and has a specific characteristic that its light transparency of portions exposed with laser light will decrease according to the intensity of the laser light, the light transparency of area 52-3 will be lower than the light transparency of areas 52-2 and 52-4, which will be lower than the transparency of areas 52-1 and 52-5. Therefore, non-uniformity of light intensity and energy distribution after the first lens FL1 is compensated for by the light attenuator OA1 comprising dielectric coating layer 52.

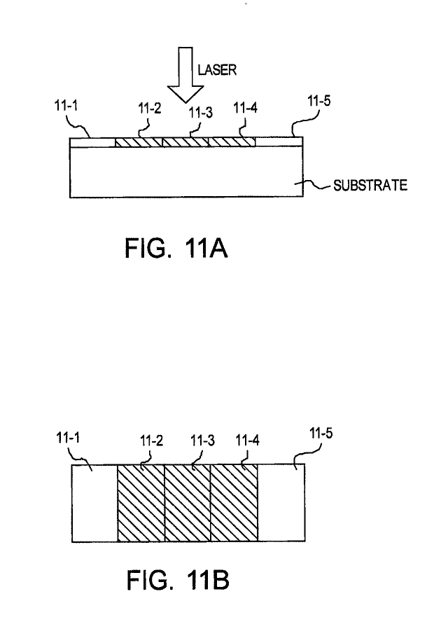

FIGS. 11A and 11B illustrate a cross sectional view and a plain view, respectively, of a fifth example of the light attenuator OA1. Light attenuator OA1 of the fifth example comprises a thermal sensitive glass, such as, but not limited to, “laser direct write (LDW) glasses”. The glass has several areas 11-1, 11-2, 11-3, 11-4 and 11-5 having different light transparencies to each other with a real gray scale which is generated by a high power laser that direct exposes the glass with different intensities for each area, respectively. For this kind of glass, increasing the laser intensity increases the light transparency thereof. This is because this kind of glass exhibits properties of light induced absorption decrease (bleaching). Thus, a high power laser source having wavelengths from near infrared (IR) to ultraviolet (JV) can be imposed onto the thermal sensitive glass and generate heat to change its transmission. Since the laser exposure intensity on area 11-3 is less than the laser exposure intensity on areas 11-2 and 11-4, which is less than a laser exposure intensity on areas 11-1 and 11-5, the light transparency of area 11-3 will be lower than the light transparency of areas 11-2 and 11-4, which will be lower than the transparency of areas 11-1 and 11-5.

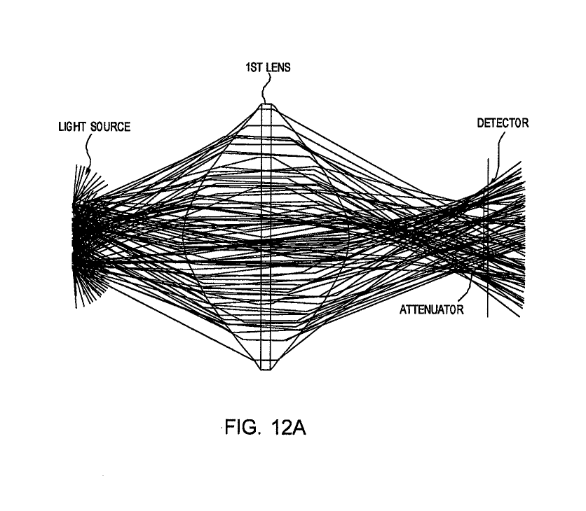

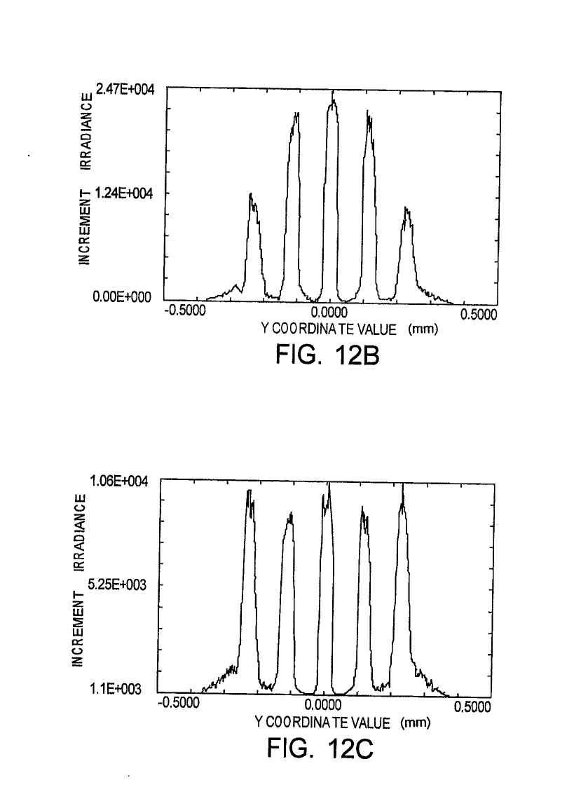

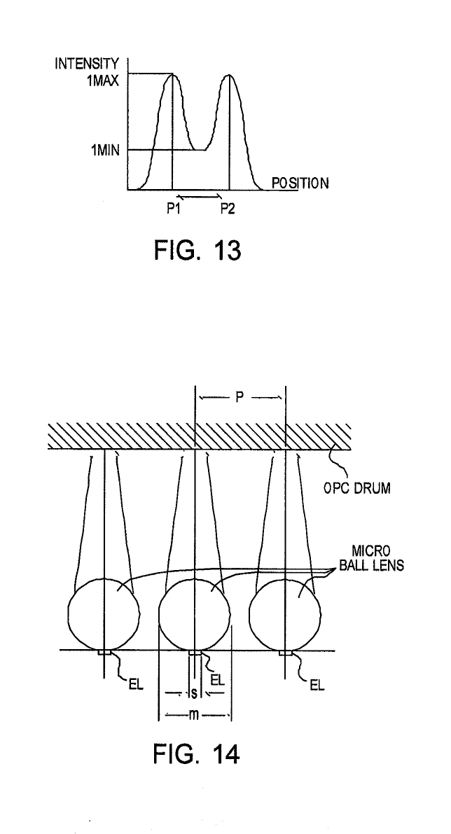

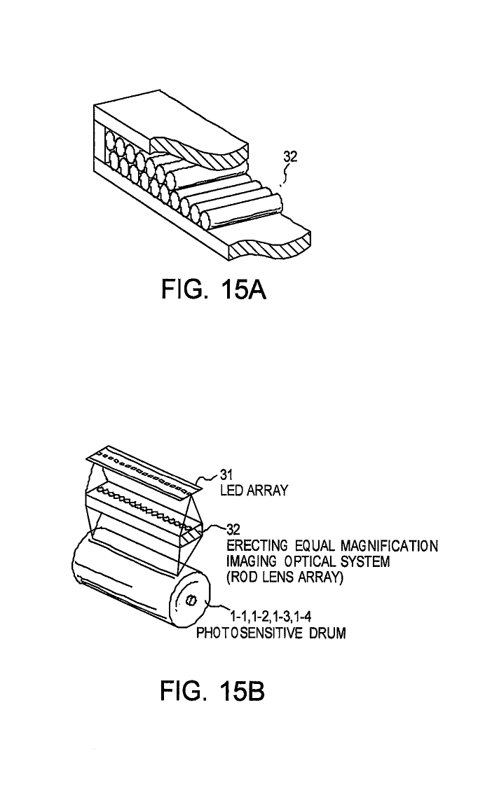

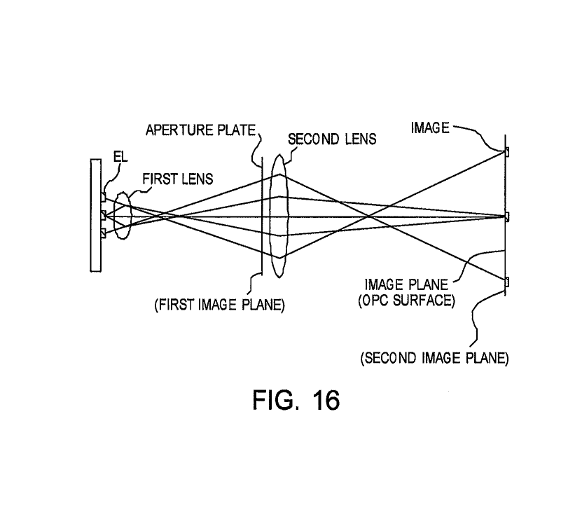

FIGS. 12A-12C show a non-sequential ray-tracing simulation result using a commercial optical design software, called ZEMAX™, in terms of light intensity distribution before and after an optical attenuator, respectively. FIG. 12A depicts a ⅔D solid model layout as a result of the non-sequential ray-tracing simulation for a model having five EL elements, a single first lens and an optical attenuator. FIGS. 12B and 12C show a cross-sectional plot of an intensity distribution before and after the optical attenuator of the model of FIG. 12A, respectively. It clearly shows that the optical attenuator improves the intensity uniformity of the light after the first lens by reducing the light intensity emitted from the center of the five EL elements without affecting the image geometry.

Although preferred embodiments and aspects of the present invention have been described and disclosed for illustrative purposes, those skilled in the art will appreciate that various modifications, additions, and substitutions are possible, without departing from the scope and spirit of the invention as set forth in the accompanying claims.

What is claimed is:

1. An optical unit for a printing apparatus, comprising:
a plurality of light emitting elements;
a lens that collects lights from the plurality of light emitting elements; and
a light filter provided in light paths of lights from the plurality of light emitting elements that compensates an intensity of the lights which pass through said lens.

2. An optical unit for printing apparatus, comprising:
a first light emitting element that emits a first light;
a second light emitting element that -emits a second light;
a lens provided in light paths of the first light and the second light, the first light and the second light passing through said lens; and
a light filter that compensates an intensity of the first and second light which passes through said lens.

3. The optical unit according to claim 2, wherein said light filter has a first portion to transmit the first light from said lens and a second portion to transmit the second light from said lens, a light transparency of said first portion being different from a light transparency of said second portion.

4. The optical unit according to claim 3, wherein said light filter comprises a transparent substrate and a light absorbing layer provided on said transparent substrate.

5. The optical unit according to claim 4, further comprising a second lens that transmits the first and second light transmitted from said light filter.

6. The optical unit according to claim 5, wherein said first and second light emitting elements comprise an organic light emitting diode.

7. A printing apparatus, comprising;
a photosensitive member;
a charger that charges said photosensitive member;
an optical unit that irradiates said photosensitive member with light to form an electrostatic latent image;
a developer that adheres toner to said photosensitive member to form a toner image of the electrostatic latent image; and
a transferor that transfers the toner image onto a recording medium,
wherein said optical unit comprises:
a plurality of light emitting elements;
a first lens that collects light from the plurality of light emitting elements;
a second lens that transmits the light from said first lens to said photosensitive member; and
a light filter provided between said first lens and said second lens, said light filter being in light paths of the light from the plurality of light emitting elements and compensates an intensity of the light which passes through said lens.
